(19) United States
(12) Patent Application Publication
(10) Pub. No.: US 2017/0346530 A1
(43) Pub. Date: Nov. 30, 2017

(54) INFORMATION COMMUNICATION APPARATUS, AND COMMUNICATION METHOD

(71) Applicant: MAKITA CORPORATION, Anjo-shi, (JP)

(72) Inventors: Hironori OGURA, Anjo-shi (JP); Junichi MURAKAMI, Anjo-shi (JP)

(73) Assignee: MAKITA CORPORATION, Anjo-shi (JP)

(21) Appl. No.: 15/593,465

(22) Filed: May 12, 2017

(30) Foreign Application Priority Data
May 30, 2016 (JP) 2016-107714

(51) Int. Cl. H04B 5/00

(52) U.S. Cl. CPC H04B 5/0037; H04B 5/0031; H04B 5/0062

(57) ABSTRACT

An information communication apparatus in one aspect of the present disclosure comprises a controller and a proximity wireless communication device. The controller performs a control process including at least transmission and/or reception of information between the information communication apparatus and at least one information holding apparatus. The at least one information holding apparatus comprises a battery pack and/or a field electric apparatus. The proximity wireless communication device communicates the information via the proximity wireless communication with an operation apparatus different from the at least one information holding apparatus.

### CROSS-REFERENCE TO RELATED APPLICATIONS

This application claims the benefit of Japanese Patent Application No. 2016-107714 filed on May 30, 2016 with the Japan Patent Office, the disclosure of which is incorporated herein by reference.

### BACKGROUND

The present disclosure relates to an information communication apparatus that performs proximity wireless communication with an information holding apparatus that holds information.

An example of an information communication apparatus (i.e., a charger or check adapter) disclosed in Japanese Patent No. 4401809 is configured to transmit and receive information to and from an information holding apparatus (i.e., a battery pack and/or a field electric apparatus) that holds information.

The information to be transmitted from the information communication apparatus to the information holding apparatus includes, for example, authentication information for theft inhibition and operation limitation information. The information to be received by the information communication apparatus from the information holding apparatus includes, for example, charging times information, battery level history information, temperature history information, charging characteristic information, battery pack type information, and past diagnostic information.

In the above example, the information communication apparatus is configured to be coupled to an operation apparatus (i.e., computer) different from the information holding apparatus, for example, via a wire cable, in order to communicate with the operation apparatus. This information communication apparatus executes a process of receiving from the operation apparatus information to be transmitted to the information holding apparatus and a process of transmitting to the operation apparatus information received from the information holding apparatus.

### SUMMARY

In the information communication apparatus of the above example, since a wire cable connecting operation for connecting the information communication apparatus to the operation apparatus is necessary upon communication with the operation apparatus, there is a possibility that the operation becomes complicated.

To avoid such possibility, information may be transmitted and received using wireless communication, for example.

However, in a case where wireless communication is performed between the information communication apparatus and the operation apparatus under an environment where a plurality of information communication apparatuses exist, it is possible that wireless communication is performed with a different information communication apparatus than the target information communication apparatus. In other words, unintended communication may be established between a non-target information communication apparatus and the operation apparatus, and erroneous communication may occur.

In one aspect of the present disclosure, it is desirable that no wire cable connecting operation is required and occurrence of erroneous communication can be inhibited.

An information communication apparatus in one aspect of the present disclosure comprises a controller and a proximity wireless communication device. The controller performs a control process including at least transmission and/or reception of information between the information communication apparatus and at least one information holding apparatus. The at least one information holding apparatus comprises a battery pack and/or a field electric apparatus. The information includes setting information to be set to the at least one information holding apparatus, and/or acquisition information acquired from the at least one information holding apparatus.

The proximity wireless communication device establishes proximity wireless communication with an operation apparatus different from the at least one information holding apparatus, and, via the proximity wireless communication, transmits and/or receives the information between the controller and the operation apparatus.

In the information communication apparatus configured as such, there is a possibility that the proximity wireless communication device is unable to communicate with an operation apparatus disposed farther away than a communicable range of the proximity wireless communication. Therefore, unless the operation apparatus is disposed within the communicable range of the proximity wireless communication, unintended communication between the information communication apparatus and the operation apparatus, that is, occurrence of erroneous communication, can be inhibited.

Therefore, in the above-described information communication apparatus, a wire cable connecting operation for communicating with the operation apparatus is not necessary and occurrence of erroneous communication with the operation apparatus can be also inhibited.

The aforementioned information communication apparatus may comprise a housing. The housing has an outer surface, and may be configured to house the controller and the proximity wireless communication device. The outer surface may include an abutting area that is configured to abut on an installation place of the information communication apparatus, and a communication area that is provided in the outer surface at a position different from the abutting area and includes the proximity wireless communication device disposed therein.

When the information communication apparatus configured as such is fixed to the installation place, the abutting area abuts on the installation place, and thus the operation apparatus may not be able to approach the abutting area. In contrast, an area different from the abutting area in the outer surface may not be covered by the installation place and may be exposed, even when the information communication apparatus is fixed to the installation place. Thus, the operation apparatus can approach the different area.

The communication area corresponds to the different area. Accordingly, even in a state where the information communication apparatus is fixed to the installation place, the operation apparatus can approach the communication area and establish communication with the proximity wireless communication device.

The proximity wireless communication device may comprise, for example, a planar antenna and the like. The communicable range of the proximity wireless communication device may be set in a range of a few centimeters to a few meters. The proximity wireless communication may be, for example, a proximity wireless communication using a load modulation scheme. The proximity wireless communication using a load modulation scheme has been put into practical use in communication methods using RFID tags and IC cards (for example, Near Field Communication (NFC)), in which a reply is sent using a transmission signal (carrier wave) from an external communication terminal (operation apparatus). The field electric apparatus may be configured to be coupled to the battery pack.

The proximity wireless communication device may be arranged in an area within 20 mm from the communication area inside the housing.

In this case, a distance from the communication area (in other words, the outer surface of the housing) to the proximity wireless communication device can be limited within a predetermined range. Also, close arrangement of the operation apparatus to the communication area allows a distance between the proximity wireless communication device and the operation apparatus to be within a certain range. As a result, favorable proximity wireless communication can be established between the proximity wireless communication device and the operation apparatus.

The outer surface may have a front area on the opposite side of the abutting area, and the communication area may be included in the front area. The front area, in other words, is an area opposite to the abutting area of the outer surface in a direction perpendicular to the abutting area.

The outer surface of the housing may include a side area which is visible when the housing is viewed from a direction parallel to the abutting area (installation place) and which does not overlap with the front area.

Since the side area is adjacent to the abutting area, the operation apparatus and the installation place may physically interfere when the operation apparatus comes close to the communication area, if, for example, the communication area is included in the side area and the size of the operation apparatus is greater than the size of the side area. In such a case, it is not possible to bring a communication device included in the operation apparatus close to the communication area, and it may be difficult to establish the proximity wireless communication between the operation apparatus (the communication device in detail) and the proximity wireless communication device.

On the contrary, if the communication area as described above is included in the front area, the possible interference between the operation apparatus and the installation place (e.g., a wall) can be reduced when the operation apparatus is brought close to the communication area. As a result, an increased degree of freedom is achieved in arrangement of the operation apparatus with respect to the housing, and the operation apparatus can be properly positioned with respect to the communication area. Thus, the proximity wireless communication between the operation apparatus and the proximity wireless communication device can be easily established.

The housing may comprise a front-side housing portion including the front area, and an abutting-side housing portion including the abutting area. The information communication apparatus may comprise an extension extending from an inner surface of the abutting-side housing portion toward an inner surface of the communication area in the front-side housing portion. The proximity wireless communication device may be disposed at a portion of the extension facing the inner surface of the communication area.

In this arrangement, upon joining the front-side housing portion and the abutting-side housing portion, a part of the extension can be disposed in the inner surface of the communication area, and the proximity wireless communication device disposed in the extension can be disposed in the inner surface of the communication area.

The controller may be fixed to the abutting-side housing portion.

The extension may be fixed to the inner surface of the abutting-side housing portion in a manner separable from the abutting-side housing portion.

Such a configuration facilitates replacement of the extension, as compared with a case where the extension is formed integrally with and non-separably from the abutting-side housing portion. Thereby, a replacement operation to replace the proximity wireless communication device or the extension can be easily performed when necessary. Also, shape change of the extension due to design change of the information communication apparatus, etc. can be easily performed when necessary.

The controller may comprise a circuit board, and the information communication apparatus may further comprise a fixing member configured to fix the extension and the controller to the abutting-side housing portion.

In this configuration, the extension (the proximity wireless communication device), the controller (the circuit board), and the abutting-side housing portion are fixed together by the fixing member. Therefore, even if an external force such as vibration is applied to the extension and the controller, a relative position between the controller and the proximity wireless communication device hardly changes. As a result, for example, in a configuration wherein the controller and the proximity wireless communication device are electrically coupled by internal wiring, disconnection of the internal wiring can be inhibited.

The proximity wireless communication device may be arranged to include the communication area in a communication direction of the proximity wireless communication.

In this case, a radio signal to be transmitted from and/or received by the proximity wireless communication device propagates in an area at least passing through the communication area. Therefore, easy match between a communication direction of the operation apparatus and the communication direction of the proximity wireless communication device can be achieved by abutment of the operation apparatus to the communication area. Further, the proximity wireless communication can be easily established between the operation apparatus and the proximity wireless communication device.

The “communication direction of the proximity wireless communication”, for example, in a case of proximity wireless communication using electromagnetic waves, means a traveling direction of the electromagnetic waves. An example of a configuration in which the proximity wireless communication device is arranged to include the communication area in the communication direction of the proximity wireless communication is, for example, a configuration in which at least a part of the “communication direction of the proximity wireless communication” matches a “direction to couple the proximity wireless communication device and the communication area”.

The housing may further comprise an apparatus attachment portion configured to allow the at least one information holding apparatus to be attached. In this case, the front area may comprise an attachment arrangement area where the apparatus attachment portion is arranged, and a non-attachment area which is an area other than the attachment arrangement area. The communication area may be disposed in a section of the non-attachment area closer to an outer peripheral edge of the front area than the attachment arrangement area.

The configuration as such hardly causes interference between the operation apparatus and the at least one information holding apparatus, when the operation apparatus is brought close to the communication area. As a result, since an increased degree of freedom of arrangement of the operation apparatus is achieved for communicating with the proximity wireless communication device using the operation apparatus, favorable proximity wireless communication can be established between the operation apparatus and the proximity wireless communication device.

The housing may comprise an apparatus attachment portion configured to allow the at least one information holding apparatus to be attached. In this case, the communication area may comprise a plane surface of which extending direction does not intersect the information holding apparatus attached to the apparatus attachment portion.

Such a configuration can inhibit interference between the operation apparatus brought close to the information communication apparatus and the at least one information holding apparatus, even if the size of the operation apparatus is greater than the size of the information communication apparatus. Therefore, even if the size of the operation apparatus is greater than the size of the information communication apparatus, an increased degree of freedom of arrangement of the operation apparatus with respect to the housing is achieved to establish the proximity wireless communication. The operation apparatus can be disposed in an appropriate position with respect to the communication area. As a result, the proximity wireless communication between the operation apparatus and the proximity wireless communication device can be established.

The information communication apparatus described above may further comprise a charger configured to charge the battery pack or may comprise the field electric apparatus. If the above information communication apparatus comprises the field electric apparatus, the information holding apparatus may be the battery pack, or may be the field electric apparatus.

Another aspect of the present disclosure provides a method of communication between a battery pack and/or a field electric apparatus and an operation apparatus, the method comprising:

acquiring information from the battery pack and/or the field electric apparatus; and

transmitting the information acquired from the battery pack and/or the field electric apparatus to the operation apparatus via proximity wireless communication.

Yet another aspect of the present disclosure provides a method of communication between a battery pack and/or a field electric apparatus and an operation apparatus, the method comprising:

receiving information from the operation apparatus via proximity wireless communication; and setting the information received from the operation apparatus in the battery pack and/or the field electric apparatus.

These communication methods can eliminate a wire cable connecting operation, and inhibit erroneous communication.

### BRIEF DESCRIPTION OF THE DRAWINGS

Example embodiments of the present disclosure will now be described below by way of example with reference to the accompanying drawings, in which:

FIG. 1 is a perspective view showing an appearance of an information communication apparatus to which a battery pack is coupled;

FIG. 2 is a front view of the information communication apparatus;

FIG. 3 is a cross-sectional view of the information communication apparatus taken along a line III-III in FIG. 2;

FIG. 4 is a rear view of the information communication apparatus;

FIG. 5 is an exploded perspective view of the information communication apparatus;

FIG. 6 is an explanatory view showing an attached and detached state between the battery pack and a hand-held electric power tool;

FIG. 7 is an explanatory view showing an attachment arrangement area A1, a non-attachment area A2, a first virtual area A2a, a second virtual area A2b, in the information communication apparatus;

FIG. 8 is a block diagram showing an electrical configuration of the information communication apparatus;

FIG. 9 is a front view of a charging apparatus;

FIG. 10 is a cross-sectional view of the charging apparatus taken along a line X-X in FIG. 9;

FIG. 11 is an explanatory view showing an attachment arrangement area A1, a non-attachment area A2, a first virtual area A2a, and a second virtual area A2b, in the charging apparatus;

FIG. 12 is a side view of the charging apparatus;

FIG. 13 is a cross-sectional view of the charging apparatus taken along a line XIII-XIII in FIG. 12; and

FIG. 14 is an explanatory view showing the information communication apparatus provided with a field electric apparatus.

### DETAILED DESCRIPTION OF THE PREFERRED EMBODIMENTS

### 1. First Embodiment

### 1-1. Overall Configuration

An information communication apparatus 120 according to an embodiment of the present disclosure will be described.

The information communication apparatus 120, which is coupled to a battery pack 40, an information input apparatus 100, an external device 150, and the like, is configured to transmit and receive various kinds of information to and from those devices so as to execute various processes. The information communication apparatus 120 is coupled to the battery pack 40 and the external device 150 by wired communication, and is coupled to the information input apparatus 100 via proximity wireless communication.

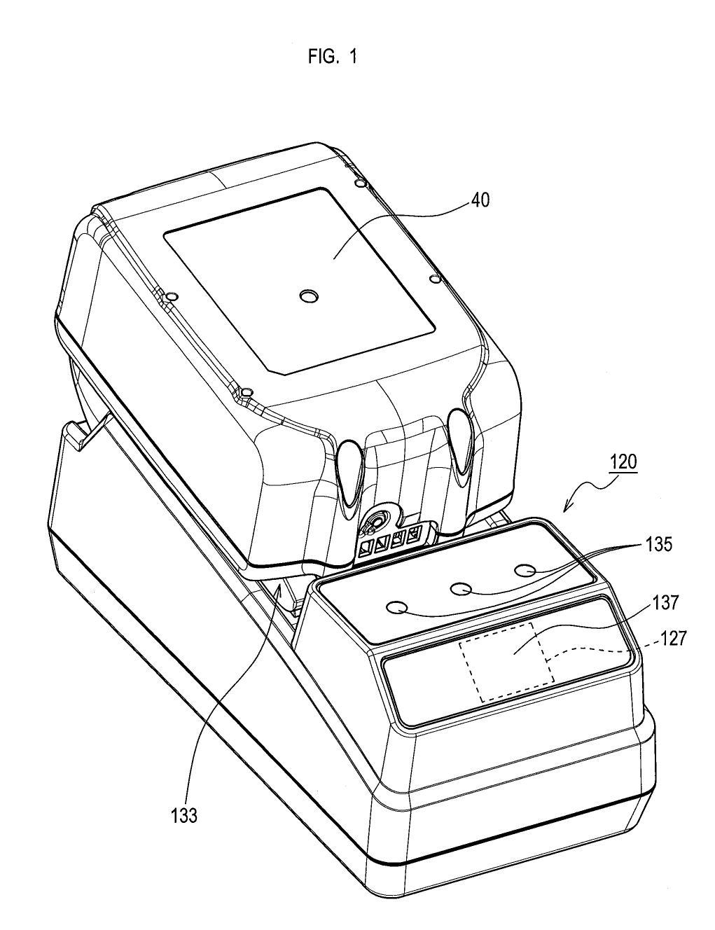

As shown in FIGS. 1 to 5, the information communication apparatus 120 comprises a battery connector 132, a battery attachment portion 133, an indicator 135, and a communication area 137.

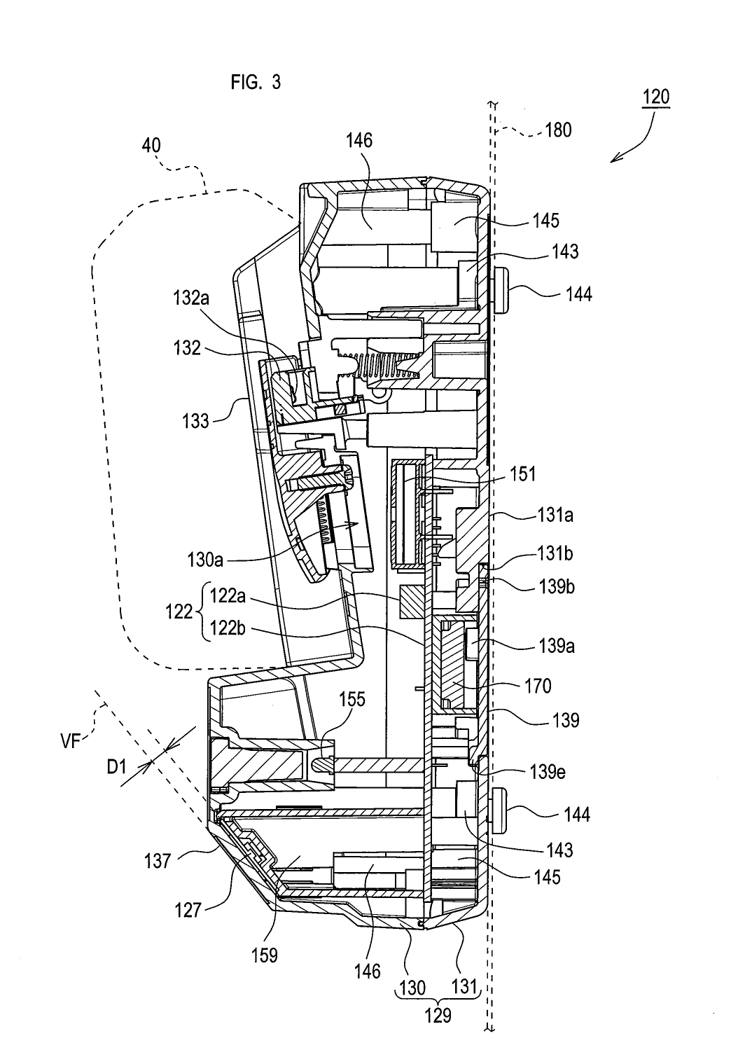

The battery connector 132, which comprises a communication connector 132a (see FIG. 3), a positive connection terminal (not shown), and a negative connection terminal (not shown), is coupled to a connector portion (not shown) of the battery pack 40. The positive connection terminal and the negative connection terminal form a power supply path to receive power supply from the battery pack 40. The communication connector 132a forms a signal path to transmit and receive various signals between the information communication apparatus 120 and the battery pack 40.

The battery attachment portion 133 is configured to allow the battery pack 40 to slide thereon in such a manner as to guide the battery pack 40 in an attachment direction of the information communication apparatus 120 and to bring the connector portion of the battery pack 40 into connection with the battery connector 132. In other words, the battery attachment portion 133 is configured to allow the battery pack 40 to be attached by moving the battery pack 40 in a state where the connector portion is facing the battery connector 132 in the attachment direction.

The indicator 135 is provided to indicate a state of the information communication apparatus 120. In this embodiment, the indicator 135 comprises three lighting portions. A LED 155 (light emitting diode 155) is provided inside each of these lighting portions.

The communication area 137 is provided with a wireless communication device 127 therein. The communication area 137 is an area where the information input apparatus 100 as a counterpart device of proximity wireless communication is brought close, when the information communication apparatus 120 performs proximity wireless communication.

The battery pack 40 is configured to be attachable to and detachable from the information communication apparatus 120. The battery pack 40 comprises a plurality of rechargeable battery cells (lithium ion cells, etc.)

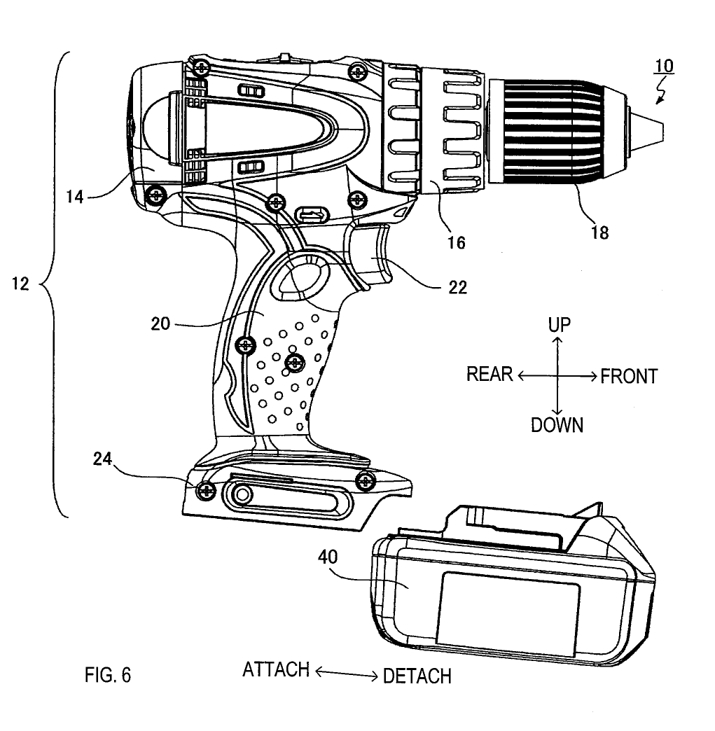

Also, the battery pack 40 is configured to be attachable to and detachable from the field electric apparatus 10, for example, as shown in FIG. 6. Specifically, the battery pack 40 is configured to be attached by moving the battery pack 40 rearward relative to the field electric apparatus 10 in a static state, and to be detached by moving the battery pack 40 forward relative to the field electric apparatus 10 in a static state.

The field electric apparatus 10 of the present embodiment is a hand-held power tool, and more specifically, a driver drill.

A working machine body 12 of the field electric apparatus 10 (the driver drill 10) comprises a motor housing 14, a gear housing 16 located in front of the motor housing 14, a drill chuck 18 located in front of the gear housing 16, and a hand grip 20 located under the motor housing 14.

The motor housing 14 houses a motor (not shown) that generates a driving force to rotationally drive the drill chuck 18. The gear housing 16 houses a gear mechanism (not shown) to transmit the driving force of the motor to the drill chuck 18. The drill chuck 18 comprises a coupling mechanism (not shown) to detachably couple a tool bit (not shown) to a front end of the drill chuck 18.

The hand grip 20 has such a shape that a user of the driver drill 10 can hold the hand grip 20 with a single hand. At an upper front of the hand grip 20, there is provided a trigger switch 22 for the user of the driver drill 10 to turn on or off the motor. At a lower end of the handle grip 20, there is provided a battery pack connector 24 to allow coupling of the battery pack 40 in an attachable and detachable manner. The field electric apparatus 10 is configured to operate using the electric power of the battery pack 40.

### 1-2. Hardware Configuration of Information Communication Apparatus

A description will be given of a hardware configuration of the information communication apparatus 120.

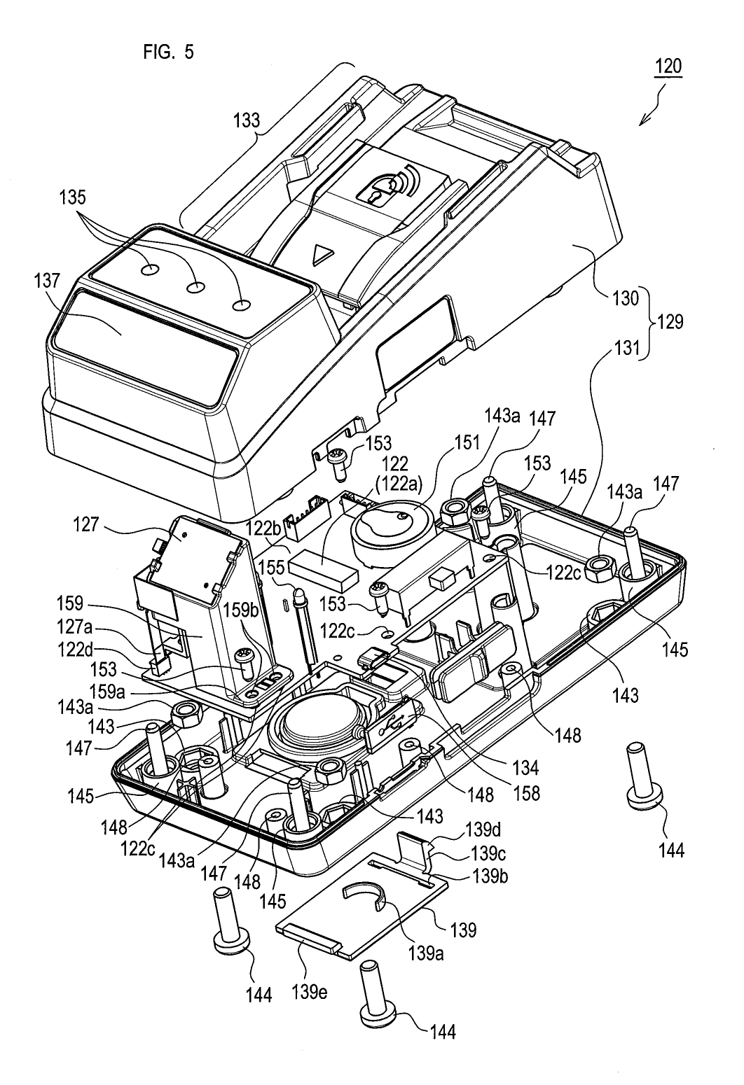

As shown in FIGS. 3 and 5, the information communication apparatus 120 comprises a housing 129. The housing 129 at least comprises therein a controller 122, a wireless communication device 127, and an extension 159.

The housing 129 comprises a first housing 130 and a second housing 131. By coupling the first housing 130 and second housing 131 in a state where the controller 122, the wireless communication device 127, the extension 159 and others are fixed to the second housing 131, the controller 122, the wireless communication device 127, the extension 159 and others become housed in the housing 129.

The controller 122 comprises a microcomputer 122a that executes various control processes, and a circuit board 122b which is formed of an insulating resin. The microcomputer 122a is attached to the circuit board 122b. Electronic components such as a USB connector 134, a buzzer 151, LEDs 155 and others are also attached to the circuit board 122b. The circuit board 122b has a plurality of through holes 122c. The controller 122 is fixed to an inner surface of the second housing 131, as fixing screws 153 are screwed into screw fixing portions 148 of the second housing 131 through the through holes 122c.

The wireless communication device 127 performs transmission/reception of various information via proximity wireless communication with the information input apparatus 100 based on commands from the controller 122. In other words, the wireless communication device 127 relays various information transmitted/received between the controller 122 and the information input apparatus 100. Examples of wireless communication methods may include, for example, a short-range wireless communication method (a so-called Near Field Communication (NFC)) in accordance with International Standards ISO/IEC 14443, Japanese Industrial Standards JISX6319-4, or the like. The wireless communication device 127 is coupled with a wiring connector 122d of the controller 122 through an internal wiring 127a. The wireless communication device 127 comprises a planar antenna.

The extension 159 is formed in an elongated shape. The wireless communication device 127 is arranged at a first end in a longitudinal direction, and a flange portion 159a is provided at a second end. The flange portion 159a is provided with a plurality of through holes 159b.

As the fixing screws 153 are screwed into the screw fixing portions 148 of the second housing 131 through the through holes 122c and the through holes 159b, the extension 159, together with the controller 122, is fixed to the inner surface of the second housing 131. The fixing screws 153 in this case are fixing members to fix the controller 122 and the extension 159 collectively to the second housing 131.

At this time, as shown in FIG. 3, the extension 159, (in particular, the inner surface of the communication area 137) is fixed to the second housing 131 so as to protrude from the inner surface of the second housing 131 toward the inner surface of the first housing 130. An end of the wireless communication device 127 where the extension 159 is arranged is formed to be parallel to the inner surface of the communication area 137 of the inner surface of the first housing 130.

Thus, the wireless communication device 127, by being fixed to a distal end portion of the extension 159, is arranged to include the communication area 137 in the communication direction of the proximity wireless communication. By disposing the wireless communication device 127 as such, a radio signal transmitted and received by the wireless communication device 127 propagates in an area to pass at least the communication area 137. In the present embodiment, at least a part of the “communication direction of the proximity wireless communication in the wireless communication device 127” matches a “direction connecting the wireless communication device 127 and the communication area 137”.

The wireless communication device 127 is disposed in a position where a distance D1 from its surface to an outer surface (specifically, the communication area 137) of the first housing 130 is 5 mm. That is, the wireless communication device 127 is disposed in an area within 20 mm in an inner direction from the outer surface of the first housing 130.

Further, the wireless communication device 127 is configured to be able to transmit and receive information to and from the operation apparatus (information input apparatus 100) via proximity wireless communication using a load modulation scheme (in the present embodiment, NFC). The wireless communication device 127 is configured to be able to transmit and receive information to and from the operation apparatus (information input apparatus 100) disposed within 100 mm at least from the communication area 137.

The first housing 130 has an opening 130a that communicates with the outside from the inside in a central portion of the battery attachment portion 133. A buzzer 151 is disposed closer to the opening 130a in the circuit board 122b. Thus, a sound emitted by the buzzer 151 is transmitted to the outside of the information communication apparatus 120 through the opening 130a.

### 1-3. Second Housing

As shown in FIGS. 3 and 5, the second housing 131 comprises nut portions 143 and coupling portions 145.

The nut portions 143, each having a structure in which a hexagonal nut 143a is embedded, are provided at four positions of the second housing 131. The hexagonal nuts 143a of the nut portions 143 are configured to be screwable with respective screw members 144. This enables the information communication apparatus 120 to be fixed to a mounting plate 180, for example, by holding the mounting plate 180 between a rear area 131a of the second housing 131 and the screw member 144, as shown in FIG. 3.

This configuration requires removing the screw member 144 from a rear side of the mounting plate 180 in order to remove the information communication apparatus 120 from the mounting plate 180. Since such removal is not easy, it is possible to inhibit theft of the information communication apparatus 120. If both of the battery pack 40 and the information communication apparatus 120 are stolen, use of the battery pack 40 may be continued by repeatedly resetting the operation permission time Tremain to the battery pack 40. In contrast, by inhibiting theft of at least the information communication apparatus 120, it is possible to inhibit continued use of the battery pack 40 due to theft of both of the battery pack 40 and the information communication apparatus 120.

The coupling portions 145, each having a shape such that a projection 146 of the first housing 130 can be fitted therein, are provided at four positions of the second housing 131, as shown in FIG. 3. When the projections 146 are fitted in the respective coupling portions 145, the first housing 130 and the second housing 131 are coupled to each other to form the housing 129 as well as the information communication apparatus 120.

Each of the coupling portions 145 has a through hole in its center, and the projection 146 is hollow in its center. From the through hole of the coupling portion 145 toward the hollow area of the projection 146, the screw member 147 is screwed and inserted. This achieves firm coupling between the first housing 130 and the second housing 131 by the screw member 147.

The USB connector 134, which is formed in a side face of the second housing 131, is disposed in a side face of the information communication apparatus 120 when the first housing 130 and the second housing 131 are coupled to each other to form the information communication apparatus 120. At an opening of the USB connector 134 of the housing 129 (first housing 130 and second housing 131), a protective cover 158 formed of a deformable resin material (such as rubber) is arranged.

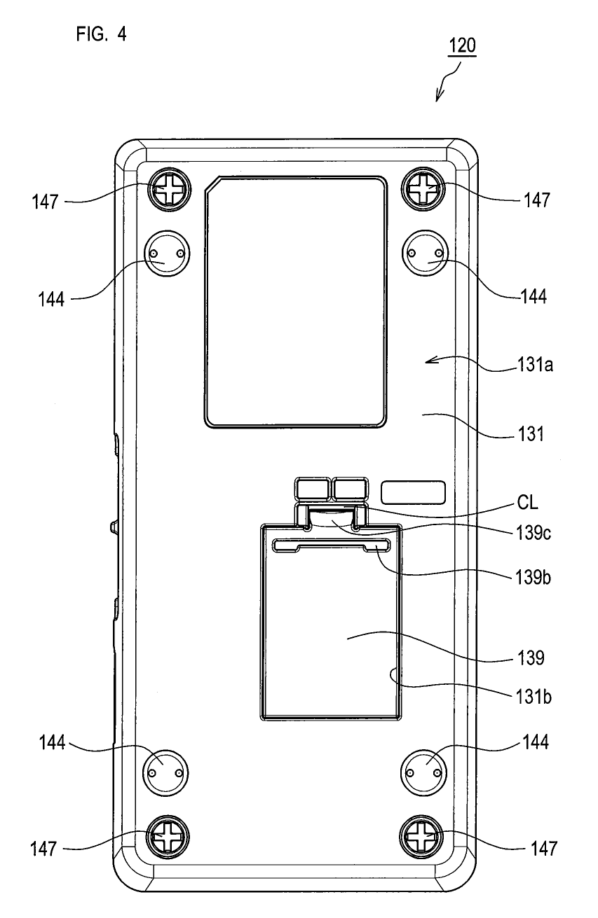

As shown in FIG. 4, the second housing 131 comprises a battery cover portion 139 in the rear area 131a. The battery cover portion 139 is configured to cover a rear opening 131b that communicates with a receiving space of an internal battery 170 (coin cell 170).

The battery cover portion 139 comprises a battery contact portion 139a that protrudes toward the inside and contacts the internal battery 170, as shown in FIGS. 3 and 5. The battery contact portion 139a limits movement of the internal battery 170, so as to inhibit the internal battery 170 from being disengaged from a terminal electrode (not shown).

The battery cover portion 139 has a cut-out portion 139b formed by being cut into an elongated shape, as shown in FIGS. 3 to 5. The battery cover portion 139 has a protrusion 139c that protrudes toward the inside of the second housing 131 at an end having the cut-out portion 139b. At a tip of the protrusion 139c, an engaging portion 139d that engages with the inner surface of the second housing 131 is provided. Movement (deformation) of the protrusion 139c in a direction in which the cut-out portion 139b becomes smaller to release engagement between the engaging portion 139d and the second housing 131 allows removal of the battery cover portion 139 from the rear opening 131b. Removal of the battery cover portion 139 from the rear opening 131b allows replacement operation of the internal battery 170.

A gap area CL between the protruding portion 139c and the second housing 131 has a gap size of 5 mm or less. For this reason, upon removal of the battery cover portion 139 from the rear opening 131b, a tool such as a flat-blade screwdriver is inserted into the gap area CL, to move (deform) the protrusion 139c. Limitation of the gap size of the gap area CL in this manner can inhibit the user from moving the protrusion 139c directly by fingers. Since a tool is required for replacing the internal battery 170, easy removal of the battery cover portion 139 can be inhibited. Further, removal of the battery cover portion 139 may be performed in a single operation of moving the protrusion 139c using a tool. Accordingly, as compared with a configuration in which a plurality of operations is required, complexity of removal of the battery cover portion 139 can be reduced.

The battery cover portion 139 has a step portion 139e at an opposite end of the protrusion 139c. Mounting of the battery cover portion 139 is performed by first engaging the step portion 139e with the inner surface of the second housing 131 (peripheral inner surface of the rear opening 131b), and then engaging the engaging portion 139d with the inner surface of the second housing 131.

### 1-4. Communication Area

The communication area 137 is provided in a front area of an outer surface of the housing 129 (first housing 130 and second housing 131).

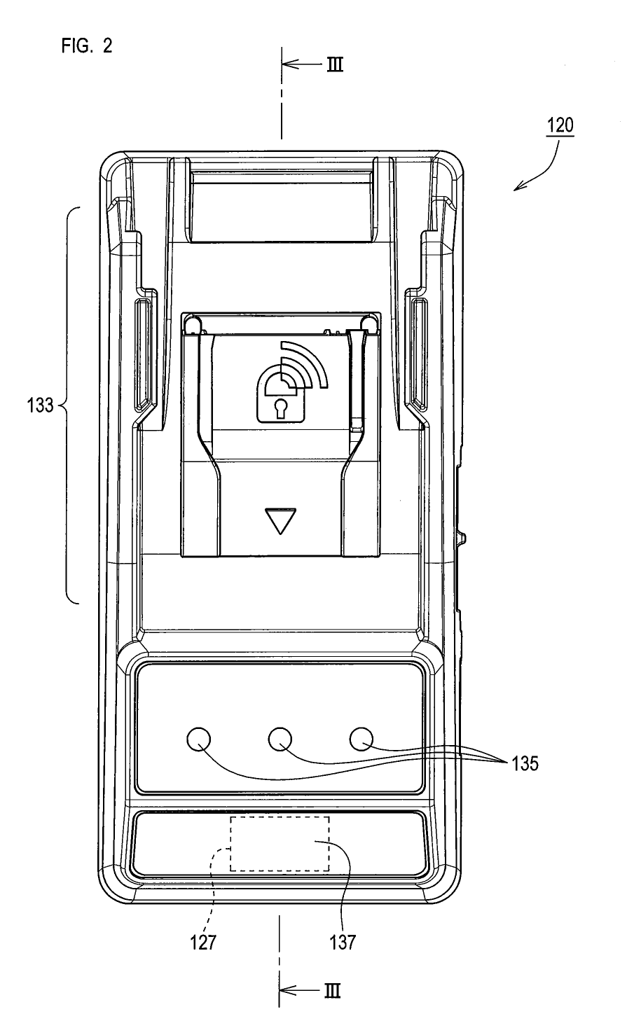

The front area is an area of the outer surface that is visible when the information communication apparatus 120 (housing 129) is viewed from the front side opposite to the rear area 131a, in a direction perpendicular to the rear area 131a. Specifically, an outer surface of the information communication apparatus 120 appearing in FIG. 2 is the front area.

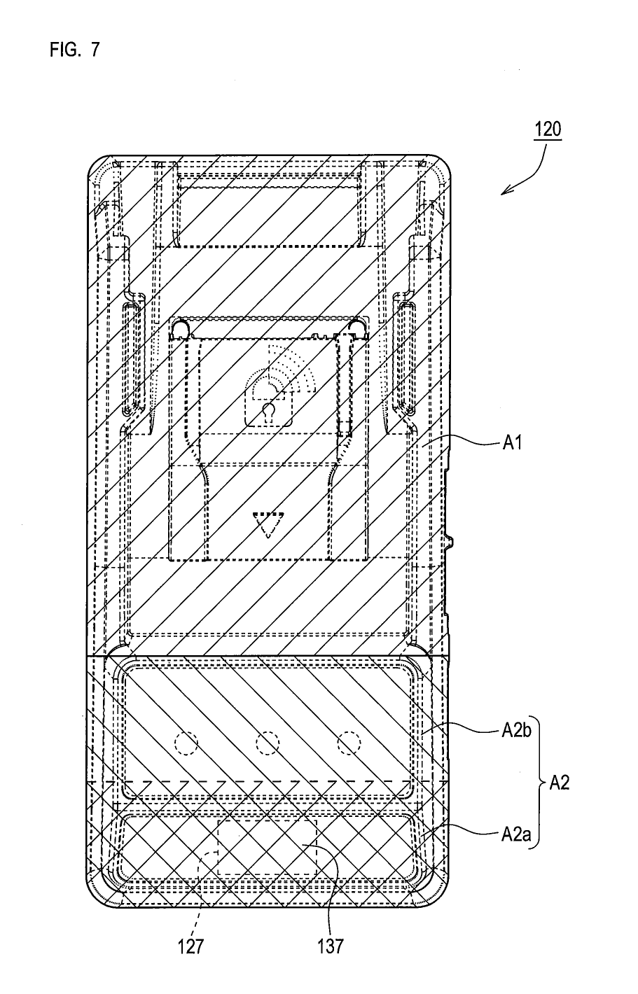

The front area, as shown in FIG. 7, includes an attachment arrangement area A1 where the battery attachment portion 133 is arranged, and a non-attachment area A2 which is an area other than the attachment arrangement area A1.

Bisection of the non-attachment area A2 to an area in contact or an area not in contact with the attachment arrangement area A1 can divide the non-attachment area A2 into a first virtual area A2a and a second virtual area A2b. That is, the first virtual area A2a is an area in contact with only an outer peripheral edge of the front area (in other words, an outer peripheral edge of the non-attachment area A2), and the second virtual area A2b is an area in contact with at least the attachment arrangement area A1.

In the information communication apparatus 120, the communication area 137 is disposed in the first virtual area A2a of the non-attachment area A2. In other words, the communication area 137 is disposed in a section of the non-attachment area A2 (first virtual area A2a; outer peripheral area) close to the outer peripheral edge of the front area than the attachment arrangement area A1.

If the communication area 137 is arranged in the first virtual area A2a of the non-attachment area A2, a distance between the communication area 137 and the battery pack 40 is increased. Thus, if the information input apparatus 100 is brought close to the communication area 137, interference between the information input apparatus 100 and the battery pack 40 hardly occurs.

The communication area 137 has a plane which is oriented such that an extending direction of the plane (see virtual extension plane VF shown in FIG. 3) does not intersect the battery pack 40 attached to the battery attachment portion 133. In the configuration as such, even if the information input apparatus 100 larger than the information communication apparatus 120 is brought close to the communication area 137, interference between the information input apparatus 100 and the battery pack 40 can be inhibited.

### 1-5. Electrical Configuration of Information Communication Apparatus

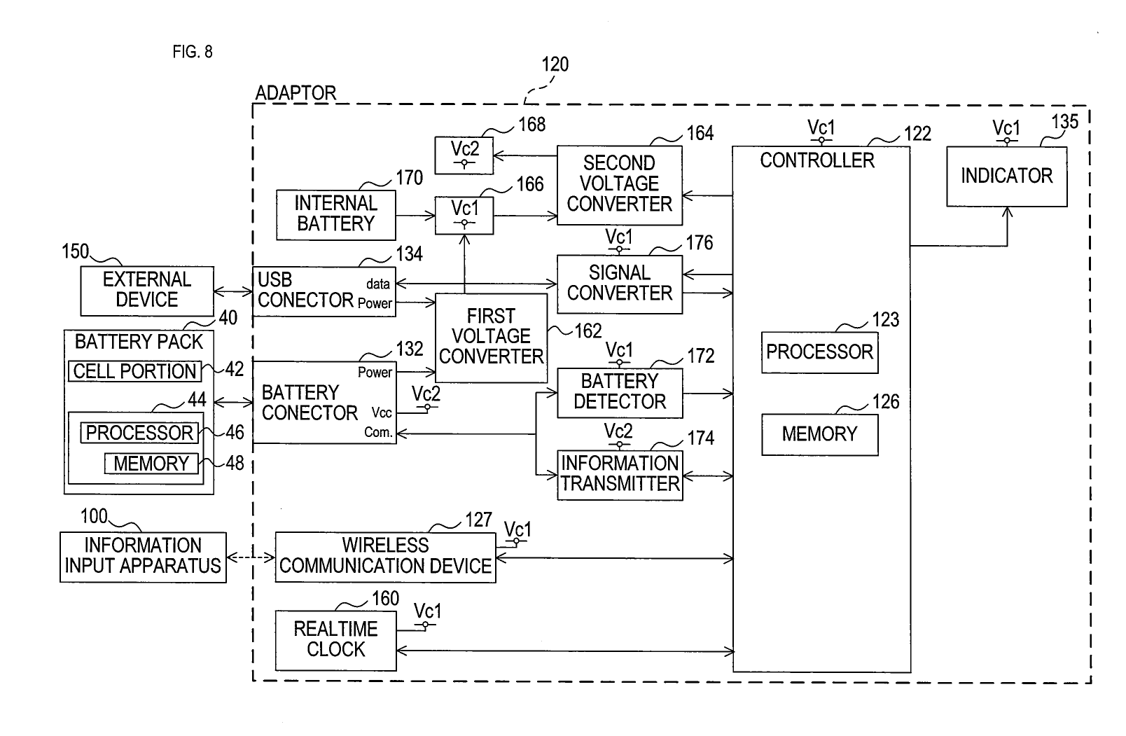

As shown in FIG. 8, the information communication apparatus 120 comprises, as electrical components, at least the controller 122, the wireless communication device 127, the battery connector 132, the USB connector 134, the indicator 135, and a real time clock 160.

The controller 122 of the first embodiment comprises a microcomputer 122a comprising at least one processor 123 and at least one memory 126. The processor 123 comprises a central processing unit (CPU) and executes various control processes in the information communication apparatus 120. The memory 126 comprises a ROM and a RAM, and stores at least programs of the various control processes to be executed by the processor 123, and data to be used for the various control processes. In another embodiment, the controller 122 may be a combination of various individual electronic parts, an Application Specified Integrated Circuit (ASIC), an Application Specific Standard Product (ASSP), a programmable logic device such as a Field Programmable Gate Array (FPGA), or a combination thereof.

As described above, the wireless communication device 127 performs transmission/reception of various information via proximate wireless communication with the information input apparatus 100 based on commands from the controller 122.

The information input apparatus 100 may be, for example, a portable information processing terminal device (such as a laptop computer, a tablet device, a smartphone, etc.) having a wireless communication function.

As described above, the battery connector 132 is configured to be coupled to the connector portion (not shown) of the battery pack 40, to thereby form the power supply path to receive power supply from the battery pack 40, and the signal path to transmit and receive various signals to and from the battery pack 40.

An output voltage (for example, 18 V) of the battery pack 40 received by the battery connector 132 (more specifically, the positive connection terminal 132b and the negative connection terminal 132c) is converted into a first drive voltage Vc1 (for example, 3.3 V) at a first voltage converter 162. The first drive voltage Vc1 outputted from the first voltage converter 162 is supplied to respective components of the information communication apparatus 120 through a first drive voltage supply device 166.

The first voltage converter 162 comprises, for example, a buck regulator that reduces an input voltage and outputs the reduced voltage. Also, the first voltage converter 162 has a function to convert an output voltage of the battery pack 40 through the battery connector 132 into the first drive voltage Vc1, as well as a function to convert a USB voltage (for example, 5 V) from an external device 150 through the USB connector 134 into the first drive voltage Vc1.

The first drive voltage supply device 166 supplies the first drive voltage Vc1 to respective components of the information communication apparatus 120 using an output voltage of the internal battery 170 when a voltage is not supplied from the first voltage converter 162. The internal battery 170 comprises a non-rechargeable battery (such as a coin battery) that outputs a voltage of the same level as the first drive voltage Vc1.

The information communication apparatus 120 also comprises a second voltage converter 164. The second voltage converter 164 converts the first drive voltage Vc1 from the first drive voltage supply device 166 into a second drive voltage Vc2 (for example, 5.0 V). Then, the second voltage converter 164 supplies the second drive voltage Vc2 to the respective components of the information communication apparatus 120 through a second drive voltage supply device 168.

The second voltage converter 164 is configured be capable of switching between a voltage conversion execution state in which voltage conversion is executed based on a command signal from the controller 122 and a voltage conversion stop state in which voltage conversion is stopped. If the information communication apparatus 120 is in an operating state that does not require the second drive voltage Vc2, the controller 122 controls the second voltage converter 164 to be in the voltage conversion stop state, to thereby reduce electric power consumption in the information communication apparatus 120.

The battery connector 132 (more specifically, the communication connector 132a) is coupled to the controller 122 through a battery detector 172 and an information transmitter 174.

The battery detector 172 detects the output voltage of the battery pack 40, determines whether the battery connector 132 is receiving the output voltage of the battery pack 40 based on a detection result, and notifies the controller 122 of a determination result. The information transmitter 174 transmits and receives various information between the controller 122 and the battery pack 40 based on commands from the controller 122.

The USB connector 134 is provided to form a power supply path to receive power supply from the external device 150 and a signal path to transmit and receive various signals to and from the external device 150 when coupled to a USB connection terminal (not shown) of the external device 150.

The USB connector 134 is coupled to the controller 122 through a signal converter 176. The signal converter 176 performs bidirectional conversion between serial communication signals transmitted and received via serial communication with the controller 122, and USB communication signals transmitted and received via USB communication with the USB connector 134. That is, the signal converter 176 performs signal conversion to transmit and receive various information between the controller 122 and the external device 150.

The external device 150 may be an information processing terminal (for example, a desktop computer, a laptop computer, a tablet device, a smartphone, etc.) having a USB connection terminal. The information processing terminal comprises, as a user interface for a user to perform input operation, a user interface allowing input of at least information intended to be set to the information communication apparatus 120. That is, the information processing terminal comprises at least a user interface allowing input of start time information (such as date, day of week, time, etc.) to start operation limitation of the field electric apparatus 10.

The indicator 135 comprises a lighting portion (such as a light emitting diode (LED) 155) that is controlled to be in a light-on state or a light-off state based on a command signal from the controller 122. In the present embodiment, the indicator 135 comprises three lighting portions (see FIG. 1). The command signal from the controller 122 to the indicator 135 is specified in accordance with a state of the information communication apparatus 120, and the indicator 135 is provided to indicate the state of the information communication apparatus 120.

The real time clock 160 has a clock function and a calendar function, and has current time information, including at least a current date, a current day of week, and a current time. In the present embodiment, the current date includes current year, month, and day. The real time clock 160 transmits the current time information to the controller 122 in response to a request from the controller 122.

The information communication apparatus 120, which comprises the aforementioned components in the electrical configuration, is coupled to the battery pack 40, the information input apparatus 100, the external device 150, and the like, and then transmits and receives various information to and from the respective components as well as executes various processes.

The various processes executed by the information communication apparatus 120 include, for example, a process of receiving the start time information from the information input apparatus 100 or the external device 150, and a process of setting operation limitation information to the battery pack 40 based on the start time information. The start time information is information indicating a time to start operation limitation (a start time) of the field electric apparatus 10 using the electric power of the battery pack 40.

The information transmitted and received between the information communication apparatus 120 and the battery pack 40 includes at least setting information that the information communication apparatus 120 sets to the battery pack 40, and acquisition information that the information communication apparatus 120 acquires from the battery pack 40. Examples of the setting information include, for example, authentication information for theft inhibition, operation limitation information, and the like. Examples of the acquisition information include, for example, charging times information, battery level history information, temperature history information, charging characteristic information, battery pack type information, past diagnostic information, and the like.

### 1-6. Battery Pack

As schematically shown in FIG. 8, the battery pack 40 comprises a battery cell portion 42 and a battery controller 44.

The battery cell portion 42 comprises a plurality of rechargeable battery cells (such as lithium-ion cells).

The battery controller 44 of the first embodiment comprises a microcomputer that comprises at least one processor 46 and at least one memory 48. The processor 46 comprises a central processing unit (CPU), and executes various control processes in the battery pack 40. The memory 48 comprises a ROM and a RAM, and stores at least programs of the various control processes to be executed by the processor 46 and data to be used in the various control processes. In another embodiment, the battery controller 44 may be a combination of various individual electronic parts, an Application Specified Integrated Circuit (ASIC), an Application Specified the Integrated Circuit (ASIC), a programmable logic device such as a Field Programmable Gate Array (FPGA), or a combination thereof.

Examples of the control processes executed by the processor 46 may include a monitoring process, and a charge/discharge control process. The monitoring process is a process to monitor whether a charge current, a discharge current, a cell voltage, a cell temperature, or the like is normal. The charge/discharge control process is a process to perform timer counting based on a counting time (a later-described operation permission time Tremain) set by the information communication apparatus 120, and permit charging/discharging while the timer counting is being performed, as well as prohibit charging/discharging once the timer counting is finished.

### 1-7. Process Executed in Information Communication Apparatus

The information communication apparatus 120 executes various processes. Examples of the processes include, for example, a process (a start time information receiving process) in which the information communication apparatus 120 receives the start time information from the information input apparatus 100, and a process (an operation limitation information setting process) in which the information communication apparatus 120 sets operation limitation information to the battery pack 40 based on the start time information.

Through execution of the start time information receiving process by the information communication apparatus 120, it is possible to set the start time information Tset1 to the information communication apparatus 120 by a user's input operation using the information input apparatus 100. Also, through execution of the operation limitation information setting process by the information communication apparatus 120, it is possible to calculate the operation permission time Tremain, during which charging/discharging is allowable, based on the start time information Tset1 and current date and time information Tnow1, and to set the operation permission time Tremain to the battery pack 40.

The operation permission time Tremain is a piece of operation limitation information to limit operation of the field electric apparatus 10 using the electric power of the battery pack 40. For the battery pack 40 to which the operation permission time Tremain is set, charging/discharging is permitted until the operation permission time Tremain elapses, and thus, operation of the field electric apparatus 10 using the electric power of the battery pack 40 is allowed. For the battery pack 40 to which the operation permission time Tremain is set, charging/discharging is prohibited once the operation permission time Tremain has elapsed, and thus, operation of the field electric apparatus 10 using the electric power of the battery pack 40 is disabled.

The information communication apparatus 120 has at least a “date and time mode” and a “day of week and time mode” as operation modes when setting the start time information. When the operation mode is the “date and time mode”, the start time information is a “date and time”, whereas, when the operation mode is the “day of week and time mode”, the start time information is a “day of week and time.”

### 1-8. Effect

As described above, in the information communication apparatus 120 of the present embodiment, the communication area 137 is provided in the front area, at a position different from the rear area 131a. More particularly, the communication area 137 is disposed in the section of the non-attachment area A2 (first virtual area A2a; outer peripheral area) in the front area, which is closer to the outer peripheral edge of the front area than the attachment arrangement area A1.

The information communication apparatus 120 configured as such can bring the information input apparatus 100 close to the communication area 137 even when the information communication apparatus 120 is fixed to the mounting plate 180, since the communication area 137 is an area provided at a different position than the rear area 131a. Thus, proximity wireless communication between the information input apparatus 100 and the wireless communication device 127 can be established.

Especially, the communication area 137 is provided in the front area rather than a side area among areas other than the rear area 131a on the outer surface of the information communication apparatus 120 (housing 129). The side area is an area on an outer surface of the information communication apparatus 120 that is visible when the information communication apparatus 120 is viewed from a direction parallel to the rear area 131a (mounting plate 180) and that does not overlap the front area.

The side area is the area adjacent to the rear area 131a of the outer surface of the information communication apparatus 120 (housing 129). Thus, for example, if the communication area is provided in the side area, the information input apparatus 100 and the mounting plate 180 (installation place) may physically interfere upon bringing the information input device 100 that is greater than the side area close to the communication area. In such a case, it is unable to bring a signal transceiver of the information input apparatus 100 close to the communication area, and proximity wireless communication between the information input apparatus 100 (signal transceiver in detail) and the wireless communication device 127 may become disabled.

In contrast, if the communication area 137 is provided in the front area as in the information communication apparatus 120, the possible interference between the information input apparatus 100 and the mounting plate 180 can be reduced when the information input apparatus 100 is brought close to the communication area 137. As a result, an increased degree of freedom is achieved in arrangement of the information input apparatus 100 with respect to the information communication apparatus 120, and the information input apparatus 100 can be properly positioned with respect to the communication area 137. Thus, the proximity wireless communication between the information input apparatus 100 and the wireless communication device 127 can be easily established.

The wireless communication device 127 is configured to be able to transmit and receive information to and from the information input apparatus 100 via proximity wireless communication (in the present embodiment, NFC) using a load modulation scheme. The wireless communication device 127 is disposed inside the communication area 137 of the first housing 130, and is configured to be able to transmit and receive information to and from the information input apparatus 100 disposed within 100 mm from the communication area 137.

The information communication apparatus 120 configured as such cannot transmit and receive information to and from the information input apparatus 100 disposed at a distance of more than 100 mm from the communication area 137. For this reason, unless the information input apparatus 100 is disposed within a range of 100 mm from the communication area 137 (in other words, communicable range via proximate wireless communication), unintended transmission and reception of information between the information communication apparatus 120 and the information input apparatus 100 can be inhibited. Erroneous transmission and reception of information can be inhibited.

Therefore, the information communication apparatus 120 requires no wire cable connecting operation in performing transmission and reception of information to and from the information input apparatus 100, and can inhibit transmission and reception of erroneous information.

Proximity wireless communication using a load modulation scheme allows highly reliable communication with very low power consumption although the communication distance is short, and thus can be effective if applied to the information communication apparatus 120 receiving power supply from the battery pack 40.

In the information communication apparatus 120, the wireless communication device 127 is disposed at such a position that a distance D1 from its surface to an outer surface (specifically, the communication area 137) of the first housing 130 is 5 mm, and is disposed in an area within 20 mm in an inner direction from the outer surface of the first housing 130.

According to the configuration as such, a distance from the communication area 137 (in other words, the outer surface of the first housing 130) to the wireless communication device 127 can be limited to a certain range. Also, a distance between the wireless communication device 127 and the information input apparatus 100 can be within a certain range by bringing the information input apparatus 100 close to the communication area. In this way, by setting the distance between the wireless communication device 127 and the information input apparatus 100 within a certain range, wireless communication between the wireless communication device 127 and the information input apparatus 100 is improved.

In the information communication apparatus 120, the housing 129 comprises the first housing 130 and the second housing 131. The information communication apparatus 120 comprises the extension 159 extending toward the inner surface of the communication area 137 of the first housing 130 from the inner surface of the second housing 131. The wireless communication device 127 is arranged at a portion facing the inner surface of the communication area 137 of the extension 159.

In the configuration as such, by coupling the first housing 130 with the second housing 131, a part of the extension 159 extending from the inner surface of the second housing 131 can be arranged in the inner surface of the communication area 137 of first housing 130. Also, the wireless communication device 127 fixed to the extension 159 can be arranged in the inner surface of the communication area 137.

The extension 159 is configured to be fixed to the inner surface of the second housing 131 in a manner separable from the second housing 131.

Such a configuration facilitates replacement of the extension 159, as compared with a case where the extension 159 is formed integrally with and non-separably from the second housing 131. Thereby, a replacement operation to replace the proximity wireless communication device 127 or the extension 159 can be easily performed when necessary. Also, shape change of the extension 159 due to design change of the information communication apparatus 120, etc. can be easily performed when necessary.

The controller 122 comprises the circuit board 122b, and the information communication apparatus 120 comprises fixing screws 153 to fix the extension 159 and the controller 122 to the second housing 131.

In this configuration, the extension 159 (the proximity wireless communication device 127), the controller 122 (the circuit board 122b), and the second housing 131 are fixed together by the fixing screw 153. Therefore, even if an external force such as vibration is applied to the extension 159 and the controller 122, a relative position between the controller 122 and the wireless communication device 127 hardly changes. As a result, for example, in a configuration where the controller 122 and the wireless communication device 127 are electrically coupled by internal wiring 127a, disconnection of the internal wiring 127a can be inhibited.

The wireless communication device 127, by being fixed to the distal end portion of the extension 159, is arranged to include the communication area 137 in the communication direction of the proximity wireless communication. By disposing the wireless communication device 127 as such, a radio signal transmitted and received by the wireless communication device 127 propagates in an area to pass at least the communication area 137. In this configuration, easy match between the communication direction of the information input apparatus 100 and the communication direction of the wireless communication device 127 is achieved by abutment of the information input apparatus 100 to the communication area 137. Further, the proximity wireless communication can be easily established between the information input apparatus 100 and the wireless communication device 127.

The housing 129 comprises the battery attachment portion 133 where the battery pack 40 is attached. The communication area 137 is disposed in the first virtual area A2a (outer peripheral area) that is a section of the non-attachment area A2 closer to the outer peripheral edge of the front area than the attachment arrangement area A1. In other words, the communication area 137 is disposed not in the second virtual area A2b (the area in contact with at least the attachment arrangement area A1) of the non-attachment area A2, but in the first virtual area A2a (area in contact with only the outer peripheral edge of the front area (in other words, outer peripheral edge of the non-attachment area A2)).

The configuration as such hardly causes interference between the information input apparatus 100 and the battery pack 40, when the information input apparatus 100 is brought close to the communication area 137 since a distance between the communication area 137 and the battery pack 40 becomes greater. As a result, since an increased degree of freedom of arrangement of the information input apparatus 100 is achieved for communicating with the wireless communication device 127 using the information input apparatus 100, favorable proximity wireless communication can be established between the information input apparatus 100 and the wireless communication device 127.

The communication area 137 comprises a plane surface. This plane is oriented such that the extension direction (virtual extension plane VF) of the plane surface does not intersect the battery pack 40 attached in the battery attachment portion 133. Such a configuration can inhibit interference between the information input apparatus 100 and the battery pack 40 even if the information input apparatus 100 having a greater size than the information communication apparatus 120 is brought close to the communication area 137

Therefore, even if communication with the wireless communication device 127 is performed using the information input apparatus 100 greater than the information input apparatus 120, an increased degree of freedom of arrangement of the information input apparatus 120 with respect to the housing 129 is achieved. The information input apparatus 120 can be disposed in an appropriate position with respect to the communication area 137. As a result, proximity wireless communication between the information input apparatus 120 and the wireless communication device 127 can be established.

In the present embodiment, the information communication apparatus 120 corresponds to an example of an information communication device, the battery pack 40 and the field electric apparatus 10 (the driver drill 10) correspond to an example of an information holding apparatus, and the information input apparatus 100 corresponds to an example of an operation apparatus.

The authentication information for theft inhibition and operation limitation information correspond to an example of setting information, the charging count information, battery level history information, temperature history information, charging characteristic information, battery pack type information, and past diagnostic information correspond to an example of acquired information.

The controller 122 corresponds to an example of a controller, the wireless communication device 127 corresponds to an example of a proximate wireless communication device, the housing 129 corresponds to an example of a housing, the rear area 131a corresponds to an example of an abutting area, and the communication area 137 corresponds to an example of a communication area.

The first housing 130 is corresponds to an example of a front-side housing portion, the second housing 131 corresponds to an example of an abutting-side housing portion, the extension 159 corresponds to an example of an extension, the fixing screws 153 correspond to an example of a fixing member, the battery attachment portion 133 corresponds to an example of an apparatus attachment portion.

The attachment arrangement area A1 corresponds to an example of an attachment arrangement area, and the non-attachment area A2 corresponds to an example of a non-attachment area.

### 2. Second Embodiment

### 2-1. Overall Configuration

As a second embodiment, a charging apparatus 220 having a function to charge the battery pack 40 will be described.

The charging apparatus 220 has a function to transmit and receive various kinds of information, in addition to the charging function, similar to the information communication apparatus 120 of the first embodiment. That is, the charging apparatus 220, which is coupled to the battery pack 40, the information input apparatus 100, the external device 150, and the like, is configured to transmit and receive various kinds of information to and from those devices to execute various processes. The charging apparatus 220 is coupled to the battery pack 40 and the external device 150 by wired communication, and is coupled to the information input apparatus 100 via proximity wireless communication.

Therefore, the description of the charging apparatus 220 hereinafter will be given mainly with respect to differences between the charging apparatus 220 and the information communication apparatus 120. The same components in the second charging apparatus 220 as those in the information communication apparatus 120 are indicated with the same respective reference numerals, and no further explanation thereof will be provided.

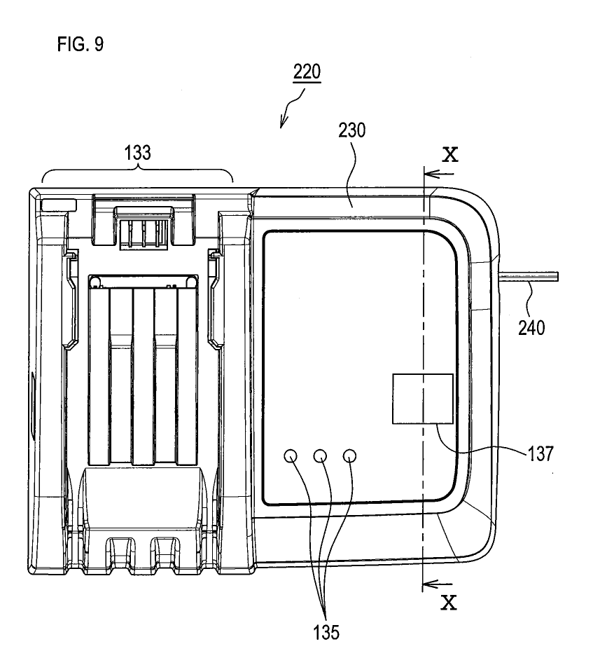

As shown in FIGS. 9 to 11, the charging apparatus 220 is configured to generate a charging voltage suitable for charging the battery pack 40 using electric power supplied from outside of the charging apparatus 220 via a power cable 240, and to be able to charge the battery pack 40 coupled to the battery attachment portion 133.

The charging apparatus 220 at least has a greater front area than the information communication apparatus 120.

The charging apparatus 220, similar to the information communication apparatus 120, comprises the battery connector (not shown), the battery attachment portion 133, the indicator 135, and the communication area 137.

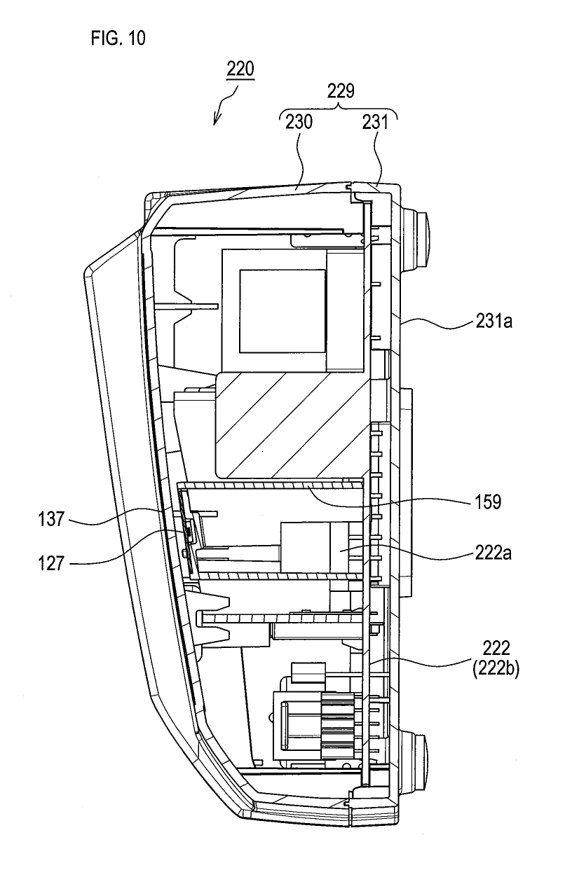

As shown in FIG. 10, the charging apparatus 220 comprise a housing 229. The housing 229 comprises therein at least a controller 222, the wireless communication device 127, and the extension 159.

The housing 229 comprises a first housing 230 and a second housing 231. By coupling the first housing 230 and second housing 231 in a state where the controller 222, the wireless communication device 127, and the extension 159 are fixed to the second housing 231, the controller 222, the wireless communication device 127, and the extension 159 become housed in the housing 229.

The controller 222, similar to the controller 122, comprises a microcomputer 222a that executes various control processes, and a circuit board 222b which is formed of an insulating resin. The microcomputer 222a is attached to the circuit board 222b. The circuit board 222b of the controller 222 is formed into a shape corresponding to the housing 229, the shape of which is different from the circuit board 122b of the first embodiment.

By inserting the circuit board 222b of the controller 222 to between the first housing 230 and the second housing 231, the controller 222 is fixed to the inner surface of the second housing 231. Electronic components such as a USB connector (not shown), a buzzer (not shown), LEDs (not shown) are also attached to the circuit board 222b.

Fixing of the circuit board 222b is not limited to the insertion. Fixing using fixing screws (not shown), as in the circuit board 122b of the first embodiment, may be employed.

### 2-2. Communication Area

The communication area 137 is provided in a front area of an outer surface of the housing 229 (first housing 230 and second housing 231).

The front area is an area of the outer surface that is visible when the charging apparatus 220 (housing 229) is viewed from the front side opposite to a rear area 231a, in a direction perpendicular to the rear area 231a. Specifically, an outer surface of the charging apparatus 220 appearing in FIG. 9 is the front area.

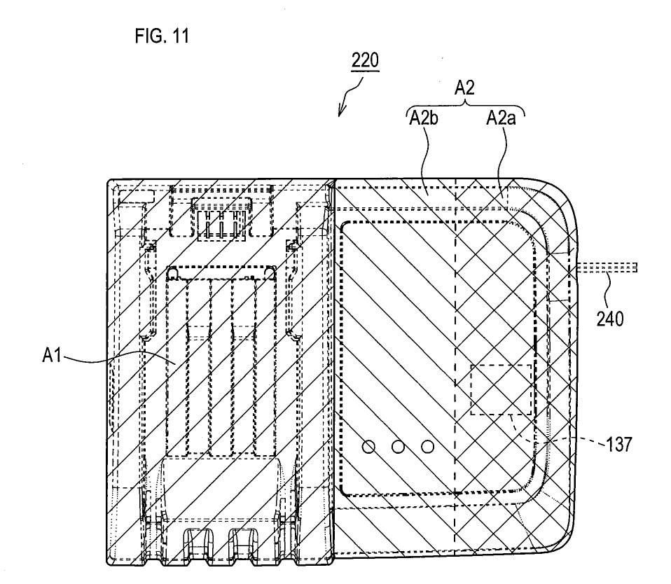

The front area, as shown in FIG. 11, includes the attachment arrangement area A1 where the battery attachment portion 133 is arranged, and the non-attachment area A2 which is an area other than the attachment arrangement area A1.

Bisection of the non-attachment area A2 to an area in contact or an area not in contact with the attachment arrangement area A1 can divide the non-attachment area A2 into the first virtual area A2a and the second virtual area A2b. That is, the first virtual area A2a is the area in contact with only the outer peripheral edge of the front area (in other words, the outer peripheral edge of the non-attachment area A2), and the second virtual area A2b is the area in contact with at least the attachment arrangement area A1.

In the charging apparatus 220, the communication area 137 is disposed in the first virtual area A2a of the non-attachment area A2. In other words, the communication area 137 is disposed in a section of the non-attachment area A2 close to the outer peripheral edge of the front area than the attachment arrangement area A1 (first virtual area A2a; outer peripheral area).

If the communication area 137 is arranged in the first virtual area A2a of the non-attachment area A2, a distance between the communication area 137 and the battery pack 40 is increased. Thus, if the information input apparatus 100 is brought close to the communication area 137, interference between the information input apparatus 100 and the battery pack 40 hardly occurs.

### 2-3. Effect

As described above, since the communication area 137 is an area provided at a position different from the rear area 231a, the charging apparatus 220 of the second embodiment, even if arranged in an installation position of the charging apparatus 220, can bring the information input device 100 close to the communication area 137. Proximity wireless communication between the information input apparatus 100 and the wireless communication device 127 can be established.

The housing 229 comprises the battery attachment portion 133 to which the battery pack 40 is attached. The communication area 137 is arranged in the first virtual area A2a (periphery area) that is a section of the non-attachment area A2 closer to the outer peripheral edge of the front area than the attachment arrangement area A1.

The configuration as such hardly causes interference between the information input apparatus 100 and the battery pack 40, when the information input apparatus 100 is brought close to the communication area 137 since a distance between the communication area 137 and the battery pack 40 becomes greater. As a result, since an increased degree of freedom of arrangement of the information input apparatus 100 is achieved for communicating with the wireless communication device 127 using the information input apparatus 100, favorable proximity wireless communication can be established between the information input apparatus 100 and the wireless communication device 127.

In the second embodiment, the charging apparatus 220 corresponds to an example of the information communication apparatus, the controller 222 corresponds to an example of the controller, the wireless communication device 127 corresponds to an example of the proximate wireless communication device, the housing 229 corresponds to an example of the housing, the rear area 231a is corresponds to an example of the abutting area, and the communication area 137 corresponds to an example of the communication area.

The first housing 230 corresponds to an example of the front-side housing portion, the second housing 231 corresponds to an example of the abutting-side housing portion, the extension 159 corresponds to an example of the extension, and the battery attachment portion 133 corresponds to an example of the apparatus attachment portion.

The attachment arrangement area A1 corresponds to an example of the attachment arrangement area, and the non-attachment area A2 corresponds to an example of the non-attachment area.

### 3. Other Embodiments

Although some embodiments of the present disclosure have been described as above, the present disclosure should not be limited to the above-described embodiments, but may be practiced in various forms without departing from the spirit of the present disclosure.

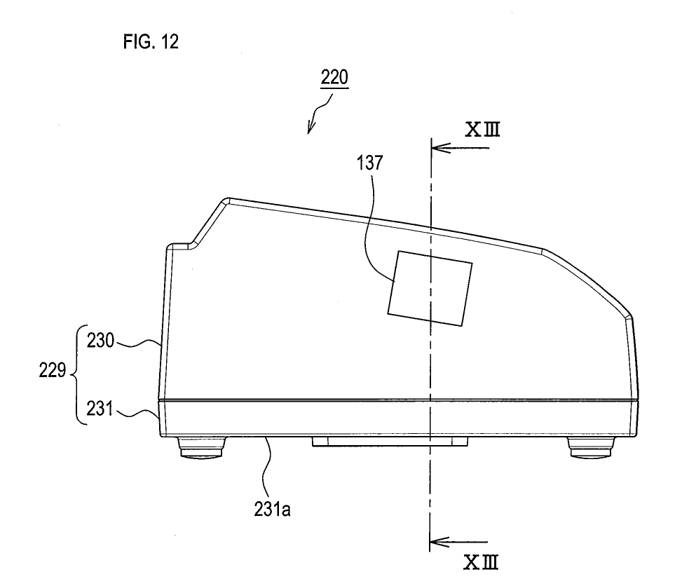

In the above-described embodiments, a configuration is described where the communication area is disposed in the front area; however, the present disclosure is not to be limited to such configuration. For example, a configuration may be employed where the communication area 137 is disposed in a side area of the outer surface, as in the charging apparatus 220 shown in FIG. 12.

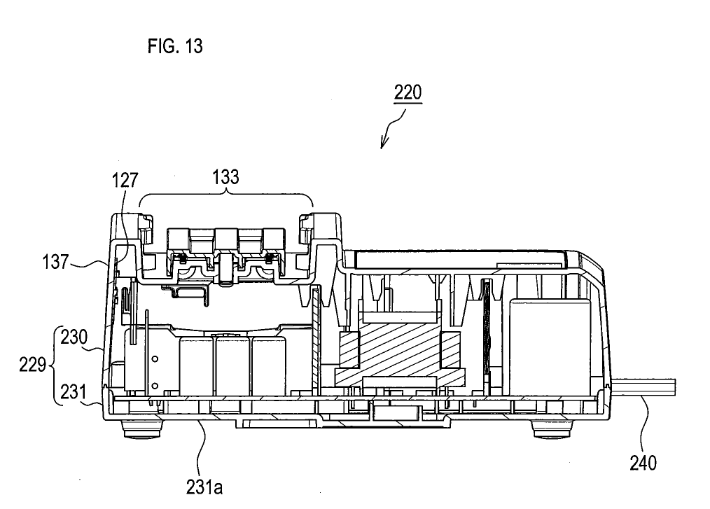

As shown in FIGS. 12 and 13, in the charging apparatus 220, the wireless communication device 127 is fixed to the inner face of the side area of the first housing 230. Also, the wireless communication device 127 is coupled to a controller (not shown) through an internal wiring (not shown). The controller is fixed to the second housing 231.

Since the communication area 137 in the charging apparatus 220 is an area provided at a different position from the rear area 231a, the information input apparatus 100 can be brought close to the communication area 137 even in a state where the charging apparatus 220 is arranged in the installation place of the charging apparatus 220. Wireless communication between the information input apparatus 100 and the wireless communication device 127 can be established.

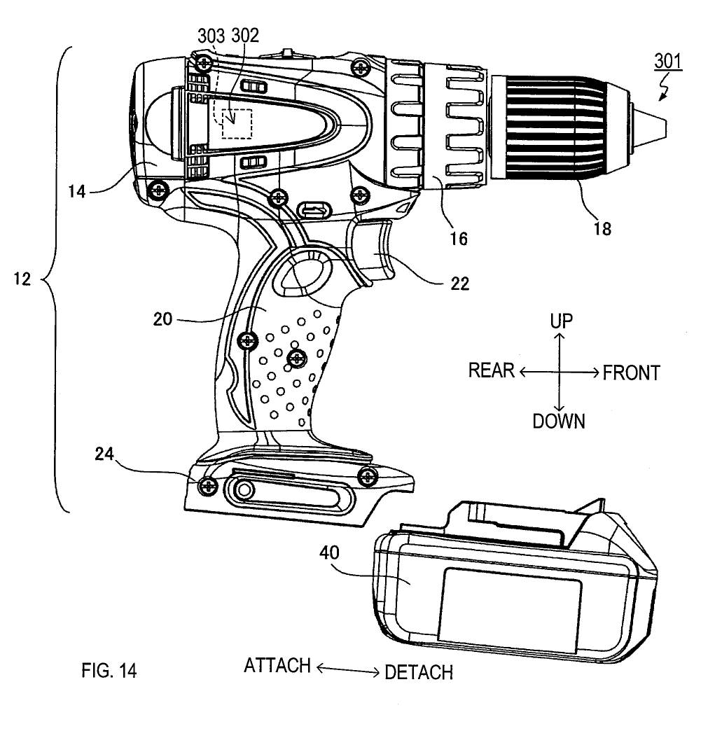

In the above-described embodiments, it is described that the information communication apparatus comprises a charger (charger configured to charge a battery pack). The information communication apparatus may comprise a field electric apparatus. For example, an information communication apparatus 301 shown in FIG. 14 has the same configuration as the above-mentioned field electric apparatus 10 and further includes a communication area 302 on the side of the working machine body 12 (in particular, the motor housing 14). The communication area 302, including therein a wireless communication device 303, is an area where the information input apparatus 100 that is a counterpart device of proximity wireless communication is brought close when the information communication apparatus 301 performs proximity wireless communication. The information communication apparatus 301 is configured to be able to transmit and receive information between the field electric apparatus 10 and the information input apparatus 100 regardless of attachment/non-attachment of the battery pack 40. Further, the information communication apparatus 301 is configured to be able to transmit and receive information between the battery pack 40 and the information input apparatus 100 when coupled with the information input apparatus 100 via proximity wireless communication in a state that the battery pack 40 is attached.

The proximity wireless communication using a load modulation scheme is not limited to NFC, and, for example, may be proximity wireless communication using RFID tags. Further, the proximity wireless communication is not limited to a load modulation scheme. Other communication scheme may be employed as long as the communicable range is set in a range of a few centimeters to a few meters.

The field electric apparatus 10 is a driver drill in the above-described embodiments, but may be any electrical device used in work site, such as DIY, manufacture, horticulture, construction work, etc. Specifically, the field electric apparatus 10 may be, for example, power tools for masonry, metalwork, or woodworking, working machines for horticulture, or electric apparatuses to arrange work site environments. More specifically, the field electrical apparatus 10 may be, for example, an electric hammer, an electric hammer drill, an electric drill, an electric screwdriver, an electric wrench, an electric grinder, an electric circular saw, an electric reciprocating saw, an electric jigsaw, an electric hammer, an electric cutter, an electric chain saw, an electric planner, a power nailer (including a tacker), an electric hedge trimmer, an electric lawn mower, an electric lawn clipper, an electric brush cutter, an electric cleaner, an electric blower, an electric sprayer, an electric sprinkler, an electric dust collector, a field light, or a field audio equipment such as a radio or a speaker.

What is claimed is:

1. An information communication apparatus comprising:
a controller configured to perform a control process including at least transmission and/or reception of information between the information communication apparatus and at least one information holding apparatus, the at least one information holding apparatus comprising a battery pack and/or a field electric apparatus, the information including setting information to be set to the at least one information holding apparatus, and/or acquisition information acquired from the at least one information holding apparatus; and
a proximity wireless communication device configured to establish proximity wireless communication with an operation apparatus different from the at least one information holding apparatus, and transmit and/or receive the information between the controller and the operation apparatus via the proximity wireless communication.

2. The information communication apparatus according to claim 1, further comprising:
a housing having an outer surface, and configured to house the controller and the proximity wireless communication device, the outer surface including an abutting area that is configured to abut on an installation place of the information communication apparatus, and a communication area that is provided in the outer surface at a position different from the abutting area and includes the proximity wireless communication device disposed therein.

3. The information communication apparatus according to claim 2,
wherein the proximity wireless communication device is arranged in an area within 20 mm from the communication area inside the housing.

4. The information communication apparatus according to claim 2,
wherein the outer surface has a front area on the opposite side of the abutting area, and
the communication area is included in the front area.

5. The information communication apparatus according to claim 2,
wherein the housing comprises a front-side housing portion including the front area, and an abutting-side housing portion including the abutting area,
wherein the information communication apparatus comprises an extension extending from an inner surface of the abutting-side housing portion toward an inner surface of the communication area in the front-side housing portion, and
wherein the proximity wireless communication device is disposed at a portion of the extension facing the inner surface of the communication area.

6. The information communication apparatus according to claim 5,
wherein the extension is fixed to the inner surface of the abutting-side housing portion in a manner separable from the abutting-side housing portion.

7. The information communication apparatus according to claim 6,
wherein the controller comprises a circuit board, and
wherein the information communication apparatus further comprises a fixing member configured to fix the extension and the controller to the abutting-side housing portion.

8. The information communication apparatus according to claim 2,
wherein the proximity wireless communication device is arranged to include the communication area in a communication direction of the proximity wireless communication.

9. The information communication apparatus according to claim 2,
wherein the housing further comprises an apparatus attachment portion configured to allow the at least one information holding apparatus to be attached,
wherein the outer surface is provided with a front area on the opposite side to the abutting area,
wherein the front area comprises an attachment arrangement area where the apparatus attachment portion is arranged, and a non-attachment area which is an area other than the attachment arrangement area, and
wherein the communication area is disposed in an area of the non-attachment area closer to an outer peripheral edge of the front area than the attachment arrangement area.

10. The information communication apparatus according to claim 2,
wherein the housing comprises an apparatus attachment portion configured to allow the at least one information holding apparatus to be attached,
wherein the communication area comprises a plane surface of which extending direction does not intersect the information holding apparatus attached to the apparatus attachment portion.

11. The information communication apparatus according to claim 1, further comprising a charger configured to charge the battery pack.

12. The information communication apparatus according to claim 1, further comprising the field electric apparatus.

13. A method of communication between a battery pack and/or a field electric apparatus and an operation apparatus, the method comprising:
acquiring information from the battery pack and/or the field electric apparatus; and
transmitting the information acquired from the battery pack and/or the field electric apparatus to the operation apparatus via proximity wireless communication.

14. A method of communication between a battery pack and/or a field electric apparatus and an operation apparatus, the method comprising:
receiving information from the operation apparatus via proximity wireless communication; and
setting the information received from the operation apparatus in the battery pack and/or the field electric apparatus.
